(19) United States
(12) Patent Application Publication
(10) Pub. No.: US 2026/0222689 A1
(43) Pub. Date: Jul. 30, 2026

(54) A CAMERA TILTING APPARATUS AND METHOD FOR VISUAL POSITIONING

(71) Applicant: Sony Group Corporation, Tokyo (JP)

(72) Inventors: Justinas MISEIKIS, Stuttgart (DE); Nabil LOGHIN, Stuttgart (DE); Klaus ZIMMERMANN, Stuttgart (DE); Faisal KAMRAN, Stuttgart (DE)

(73) Assignee: Sony Group Corporation, Tokyo (JP)

(21) Appl. No.: 19/148,330

(22) PCT Filed: Feb. 1, 2024
(86) PCT No.: PCT/EP2024/052510

§ 371 Date: Jul. 16, 2025

(30) Foreign Application Priority Data
Feb. 2, 2023 (EP) 23154786.0

(51) Int. Cl. H04N 23/695

(52) U.S. Cl. CPC H04N 23/695

(57) ABSTRACT

An electronic device has circuitry, which is configured to adjust the field of view (FoV) of a camera to enhance tracking and/or visual positioning.

### TECHNICAL FIELD

The present disclosure generally pertains to the field of augmented reality, in particular to augmented reality devices and methods for tracking and visual positioning in virtual and augmented reality systems.

### TECHNICAL BACKGROUND

To provide a realistic and effective virtual or augmented reality user experience, including, for example, accurate overlays of virtual objects onto the real world, virtual and augmented reality systems make use of cameras in moveable or wearable devices for tracking and visual positioning purposes.

Traditional tracking systems, such as GPS systems, may lack the necessary high accuracy for a realistic virtual experience. According to alternative technologies such as Simultaneous Localization and Mapping (SLAM), visual information from the camera may be used for estimating position and orientation in 3D space within the cm or even sub-cm range.

Although there exist techniques for visual positioning, it is generally desirable to improve these existing techniques.

### SUMMARY

According to a first aspect, the present disclosure provides an electronic device comprising circuitry configured to adjust the field of view of a camera to enhance tracking and visual positioning.

According to a second aspect, the present disclosure provides a method comprising adjusting the field of view of a camera so that it is independent of the device tilt.

According to a third aspect, the present disclosure provides a computer program comprising instructions which, when executed by a processor, performs the method.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 schematically shows an embodiment of a mobile device with a camera containing a tilting mechanism for adjusting the field of view (FoV) of the camera to enhance tracking and visual positioning;

FIG. 2 schematically shows an embodiment of a camera including a tilting mechanism for adjusting the field of view (FoV) of the camera to enhance tracking and visual positioning;

FIG. 3a schematically shows an embodiment of a camera configuration with a tilting mechanism including a mirror for adding a new optical path;

FIG. 3b schematically shows the camera configuration of FIG. 3a in a different state;

FIG. 4 schematically shows an embodiment of a mobile device with two camera modules including one wide angle lens;

FIG. 5 schematically shows an example of a configuration of a visual positioning system with tilt adjustment procedure for a camera of a mobile device, the camera including a tilting mechanism;

FIG. 6 schematically shows an example of a configuration of a tilt adjustment procedure for a camera for adjusting the field of view (FoV) of the camera to enhance tracking and visual positioning, the tilt adjustment being based on information from an inertial measurement unit;

FIG. 7 schematically shows a user holding a mobile device including a camera in different device tilt positions and how a tilting mechanism included in the camera for adjusting the field of view (FoV) of the camera to enhance tracking and visual positioning may compensate for a device tilt;

FIG. 8 schematically shows a configuration of a tilted mobile device with a camera including a tilting mechanism for adjusting the field of view (FoV) of the camera to enhance tracking and visual positioning;

FIG. 9 schematically shows a configuration of a visual guidance of a camera of a mobile device including a tilting mechanism;

FIG. 10 shows an example of a 3D model of a detail of a scene as produced by 3D reconstruction such as described in FIG. 5 and as used for tilt adjustment as described in FIG. 9;

FIG. 11 shows a graph of surface element density according to angular sectors. The b axis of the graph reflects the angular sectors b1 to b9 as illustrated and described in regard to FIG. 9;

FIG. 12 shows a block diagram depicting an embodiment of a visual positioning process using image data of a wide-angle camera;

FIG. 13 shows a block diagram depicting the switching of the field of view of a camera between a field of view congruent to the device tilt and an adjusted field of view for enhanced tracking and visual positioning; and

FIG. 14 shows a block diagram depicting an embodiment of an electronic device, e.g., a mobile device such as a smartphone or the like, that can implement the process of tilt adjustment for a camera including a tilting mechanism for adjusting the field of view (FoV) of the camera to enhance tracking and visual positioning.

### DETAILED DESCRIPTION OF EMBODIMENTS

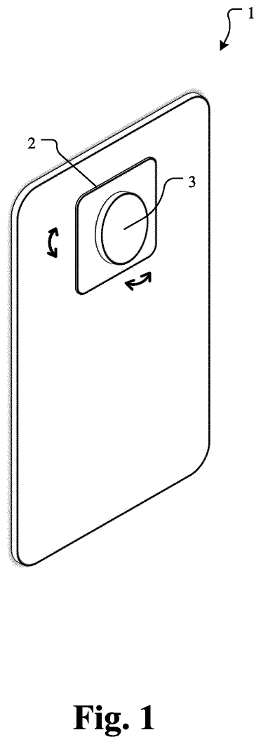

Before a detailed description of the embodiments under reference of FIG. 1 is given, general explanations are made.

It has been recognized, that for the experience of effective Augmented Reality, Mixed Reality, or Extended Reality (AR/MR/XR), it is essential to have a precise tracking and visual positioning (VPS) in the device used for AR, MR or XR purposes. Traditional tracking systems, such as GPS Global Positioning System) or similar approaches may not be accurate enough and may also lack indoor reception and various inertial sensors, such as IMUs (Inertial Measurement Units) may suffer from drift. Other state-of-the-art indoor localization technologies also may lack the high-accuracy requirements, which are needed to overlay virtual objects onto the real-world.

In some embodiments, for example, visual information may be used, typically the input gathered from a camera, to localize the device by comparing the view seen of the camera to the pre-created map of the area. In this way the position and the orientation (both usually measured with 6 degrees of freedom (DoF), i.e., 3 DOFs for position and another 3 DOFs for the orientation) may be estimated in an accurate manner, within cm or even sub-cm accuracy. Alternatively, in some embodiments, instead of comparing the view seen of the camera with a pre-created map also Simultaneous Localization and Mapping (SLAM) may be used, which continuously creates an updated map of the area based on the image data of the camera.

It has been recognized that the use of portable or wearable devices for AR applications may come with an inconvenience: objects of interest for the VPS may not be visible in the field-of-view (FoV) of the camera because of angular inclination of the device, therefore, restricting precise positioning.

Hence, some embodiments pertain to an electronic device comprising circuitry configured to adjust the field of view (FoV) of a camera to enhance tracking and/or visual positioning.

The electronic device may for example be a mobile device such as a smartphone, smart glasses, a head-mounted display (HMD), earphones, or the like.

The circuitry may include a processor, a memory (RAM, ROM or the like), a storage, input means (mouse, keyboard, camera, etc.), output means (display (e.g., liquid crystal, (organic) light emitting diode, etc.), a (wireless) interface, etc., as it is generally known for electronic devices (smartphones, tablet computers etc.). Moreover, it may include sensors for sensing still image or video image data (image sensor, camera sensor, video sensor, etc.), etc.

The circuitry may be configured to adjust the field of view (FoV) of a camera in order to compensate for device tilt. In this way the field of view (FoV) of the camera may for example be made independent of the device tilt.

The circuitry may be configured to adjust the direction of the field of view (FoV) of the camera to enhance tracking and/or visual positioning.

The circuitry may be configured to adjust the field of view (FoV) of the camera by directing the field of view at a predefined region.

The circuitry may be configured to adjust the field of view (FoV) of the camera by directing the field of view at the horizon.

The circuitry may be configured to adjust the field of view (FoV) of the camera by directing the field of view (FoV) of the camera at a region which is particularly suitable for the purpose of tracking and/or visual positioning.

The circuitry may be configured to adjust the field of view (FoV) of the camera by guiding the field of view (FoV) of the camera based on information describing structural density of a region.

The circuitry may be configured to adjust the field of view (FoV) of the camera by guiding the field of view (FoV) of the camera based on information describing visual objects imaged by the camera or the texture of visual objects imaged by the camera.

The circuitry may be configured to guide the field of view towards the most reliable objects for tracking and/or visual positioning.

The circuitry may be configured to adjust the field of view of the camera by switching between a predefined angle of the smartphone and a second angle which is optimized for tracking and/or visual positioning. The camera adjustment may for example happen fast enough to seamlessly switch from the angle of the smartphone (e.g., 45° tilt) to the optimum VPS angle (e.g., 0° tilt). In this way, the user can still see the overlay AR features in front of him/her, while at the (almost) same time, tracking is happening with camera input at the extended angle (facing horizon). Similarly, one tilted camera may be tilted for correct VPS, while overlay is done on the view of another camera FoV providing the actual view that the user is pointing the camera towards.

The circuitry may be configured to adjust the field of view of the camera by tilting the camera.

In some embodiments the electronic device may provide a lens configuration to allow for varying FoV. For example, a lens design may be provided to allow for varying FoV.

In some embodiments the circuitry may be configured to provide new optical paths by controlling tiltable mirrors or switching mirrors. For example, the optical path of a camera lens may be diverted to a sensor based on at least one mirror.

The circuitry may be configured to obtain a current tilt angle based on information from a pose estimation.

The pose estimation may be based on at least one of information obtained by an inertial measurement unit, image data obtained from a camera, or data obtained from a depth camera. By using IMU data the circuitry can for example adjust for gravity to aim the camera at the horizon.

The circuitry may be configured to obtain wide-angle image data from a wide-angle camera, and adjust the field of view of the camera based on wide-angle image data. A large FoV lens may for example be a wide-angle lens or may comprise stitching of FoVs from multiple camera modules on the same device.

The circuitry may be configured to implement digital image processing on the wide-angle image data. The image processing may for example comprise an image correction. For example, the circuitry may be configured to obtain edge image data based on the edges of the field of view of the camera, implement digital image correction on the edge image data by segmenting the edge image data, and perform tracking and/or visual positioning based on the edge image data.

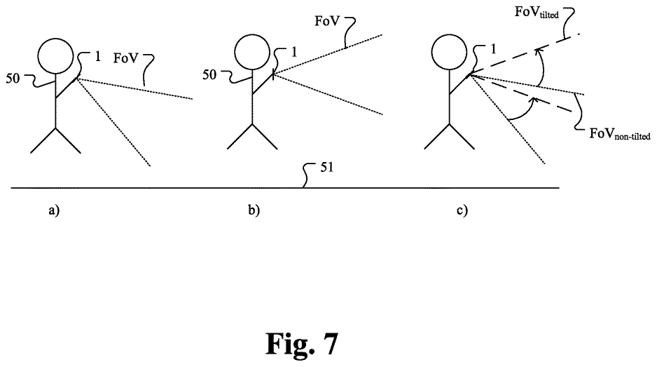

The circuitry may be configured to segment the field of view (FoV) of a camera and use the information for tracking and/or visual positioning. For example, the circuitry may be configured to switch the field of view of the camera between a field of view congruent to the device tilt and a field of view wherein the camera is adjusted to aim at the horizon, to present images based on the field of view congruent to the device tilt on a display to a user, to obtain image data of the camera with a field of view aimed at the horizon, and to perform tracking and/or visual positioning based on the image data of the camera with a field of view aimed at the horizon. The adjustment of the field of view may be based on a machine learning algorithm or conventional algorithm. For example, if a user is holding the electronic device, such as a smartphone, not at a static or constant angle, at which the user is holding the smartphone comfortably (see, for example, FIG. 7a). Instead, in an extreme case, the user may walk in a natural way, i.e., by slightly swinging the arm holding the smartphone. Such swing may to a large extend be periodical and may be predicted by the machine learning or conventional algorithms. Thus, predictive correction of camera adjustment may be applied.

In some embodiments the circuitry may be configured to switch between rear- and front-facing cameras to find an optimal VPS tracking space.

Some embodiments pertain to a method comprising adjusting the field of view (FoV) of a camera so that it is independent of the device tilt. The method may also implement any one or more of all the processes described above.

Some embodiments pertain to a computer program comprising instructions which, when executed by a processor, performs the method.

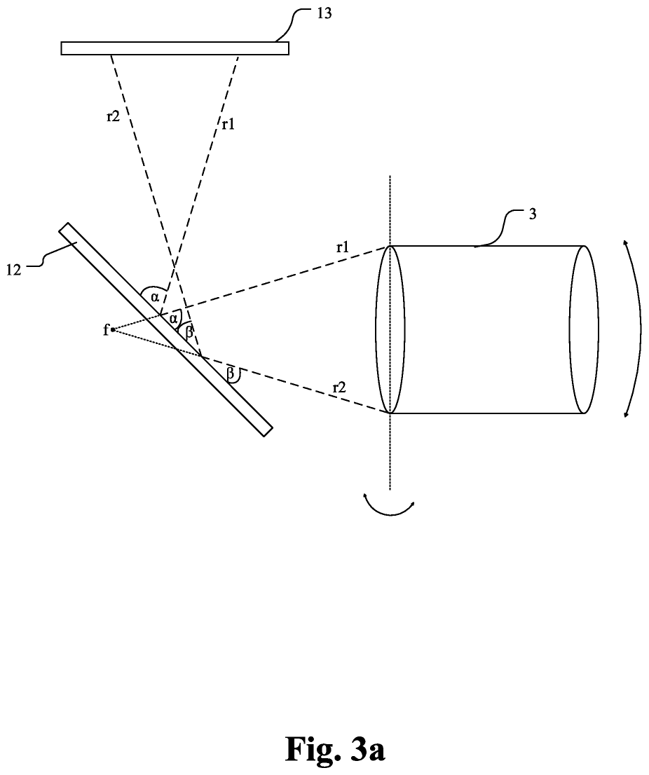

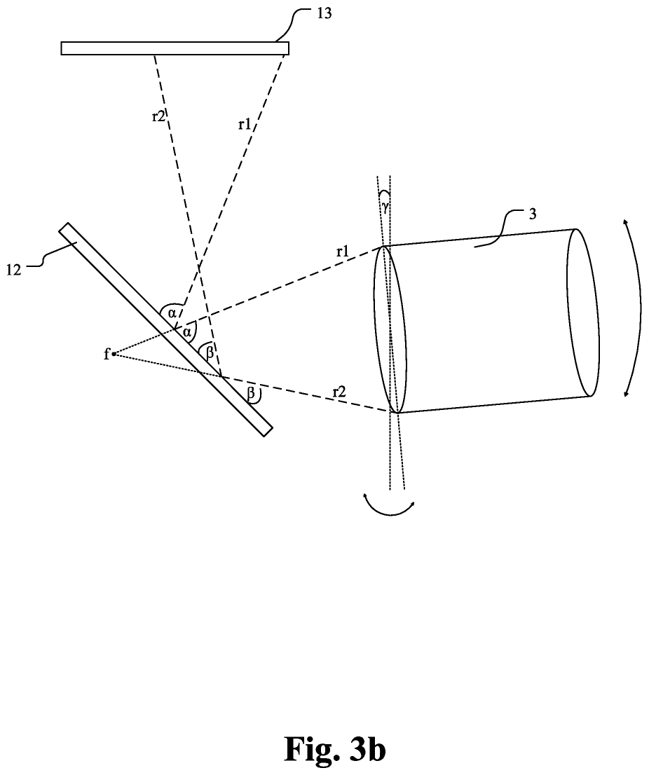

FIG. 1 schematically shows an embodiment of a mobile device with a camera containing a tilting mechanism for adjusting the field of view (FoV) of the camera to enhance tracking and visual positioning. A mobile device 1 has a camera 2 on the backside opposite to the display side. The camera 2 includes a tilting mechanism for tilting the camera 2. The camera 2 includes a lens 3 which focuses light on a sensor (see 13 in FIGS. 3a, 3b). The mobile device 1 further includes a tilting mechanism (not visible in FIG. 1) for tilting the camera 2. The tilting mechanism is installed in the mobile device 1 and is configured to tilt the camera 2 with respect to the mobile device 1. For example, as indicated by arrows in FIG. 1, the tilting mechanism may realize horizontal or vertical pivoting motions of the camera 2.

The tilting mechanism may for example be implemented as a motor which is embedded in the mobile device 1 and which drives a joint in order to enable tilting motions with the camera 2, that is, for example, horizontal or vertical pivoting motions. The tilting mechanism may for example be the tilting mechanism used for image stabilization in the Nidec Sankyo TiltAC, for example the di- or triaxial stabilization (https://www.nidec.com/en/technology/casestudy/tiltac_new), or the tilting mechanism as disclosed in the U.S. Pat. No. 9,667,848 B2, for example the tilting mechanism of the tiltable camera module, or a scaled down version of the tilting mechanism used in the Raspberry Pi Zero Wireless Pan-Tilt Camera including a pan/tilt bracket with servos, or the like.

In FIG. 1, the camera 2 is provided on the rear side of the mobile device, opposite to the display side. It should, however, be noted that in alternative embodiments, the camera 2 may be located on the front side of the mobile device.

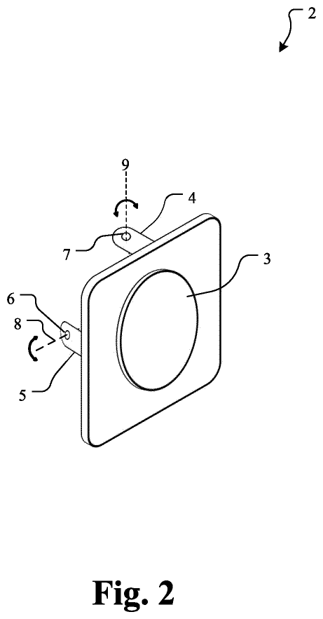

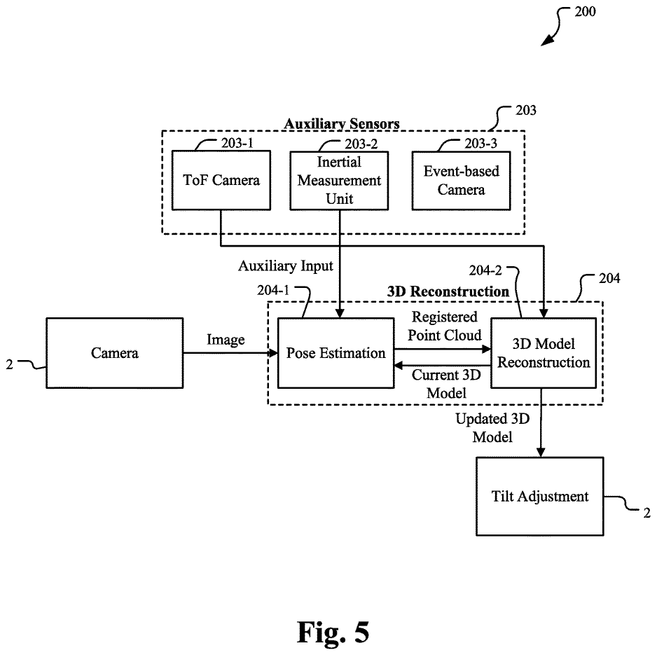

FIG. 2 schematically shows an embodiment of a camera including a tilting mechanism for adjusting the field of view (FoV) of the camera to enhance tracking and visual positioning. The camera 2 comprises a lens 3 which focuses light on a sensor (see 13 in FIGS. 3a, 3b) of camera 2. The camera 2 further comprises an upper horizontal pivoting arm 4, a lower horizontal pivoting arm (not shown in FIG. 2), a left vertical pivoting arm 5, and a right vertical pivoting arm (not shown in FIG. 2) attached to the backside of the camera 2. The horizontal pivoting arm 4 is attached at the top edge of the camera 2 and the vertical pivoting arm 5 is attached at the side edge of the camera 2. The horizontal pivoting arm 4 includes a horizontal pivoting point 7 on a pivoting axis 8 around which the camera 2 can be tilted horizontally. The vertical pivoting arm 5 includes a vertical pivoting point 6 on a pivoting axis 9 around which the camera 2 can be tilted vertically. A motor (not visible in FIG. 2) is used to drive the horizontal and vertical pivoting motions of the tilting mechanism. By pivoting the camera 2 horizontally around the pivoting axis 9 or vertically around the pivoting axis 8, or both, the direction of the FoV of the camera 2 is adjustable. Thus, the FoV of the camera 2 can be adjusted to enhance tracking and visual positioning as it is described in more detail with regards to FIGS. 5 to 11 below.

It should be noted that the disclosure is not limited to the example given in FIG. 2. Other configurations of pivoting arms 4, 5 attached, for example, at the bottom, the left side or other places on the back of the camera 2 are also possible. Other types of pivoting constructions with more degrees of freedom, for example, with one pivoting point for both, horizontal and vertical pivoting motions, are also possible. Other types of constructions that may move the camera 2 or the lens 3 are also possible, for example shift constructions, that may allow the camera 2 or lens 3 to be shifted. Thus, implementing a lens design coupled with a lens tilt and/or shift control may allow for varying FoV of the camera 2.

FIG. 3a schematically shows an embodiment of a camera configuration with a tilting mechanism including a mirror for adding a new optical path. In the example of FIG. 3a a lens 3 is provided to focus incoming light onto a focal point f. A tiltable mirror 12 is arranged to deflect the optical path of a tiltable lens 3 by a configurable angle, here 90°, towards a sensor 13. Sensor 13 is configured to generate an image based on the captured light. A ray r1 of the light that is collected by lens 3 hits the surface of mirror 12 facing the lens 3 at an incidence angle α and is reflected from the mirror 12 to the sensor 13 under the angle of reflection α. The incidence angle α equals the angle of reflection α. An optical ray r2 hits the surface of the mirror 12 at an incidence angle β and is reflected from the mirror 12 to the sensor 13 under the angle of reflection β. The incidence angle β equals the angle of reflection β.

By tilting the mirror, the optical path of the camera 2 is changed so that new optical paths (dependent on the mirror tilt) can be added to the capabilities of the camera system. By adding new optical paths, the field of view (FoV) of the camera 2 may be made adjusted to enhance tracking and visual positioning as explained in more detail in the embodiments of FIGS. 5 to 11 below.

Mirror 12 may for example be a MEMS mirror that can be tilted to different degrees depending on the optical path of the lens 3. In this way the optical path of the lens 3 of the camera 2 is always deflected to the sensor 13 even if the lens 3 of the camera 2 is tilted as illustrated in FIG. 3b.

FIG. 3b schematically shows the camera configuration of FIG. 3a in a different state. In the example of FIG. 3b lens 3 is vertically tilted (upwards) according to angle γ. Lens 3 may for example be pivoted vertically around a pivoting axis (8 of FIG. 2) according to the principle set out in FIG. 2 above. This tilting leads to a shift in the optical paths of the lens 3 in comparison to the optical path of the lens of FIG. 3a. The tilted lens 3 focuses incoming light onto a focal point f. Mirror 12 is arranged to deflect the optical path of the tilted lens 3 by an angle towards a sensor 13 which is configured to generate an image based on the captured light. The ray r1 hits the surface of tilted mirror 12 facing the lens 3 at an incidence angle α and is reflected from the mirror 12 to the sensor 13 under the angle of reflection α. The incidence angle α equals the angle of reflection α. The optical ray r2 of the lens 3 hits the surface of the mirror 12 at an incidence angle β and is reflected from the mirror 12 to the sensor 13 under the angle of reflection β. The incidence angle β equals the angle of reflection β. Both deflected rays hit the sensor 13 at a different position, closer to the right edge of the sensor 13, in comparison to the rays coming from the non-tilted lens 3 of FIG. 3a. By tilting mirror 12, this shift can be compensated for so that the light collected by lens 3 hits the sensor 13 in a central region. That is, the mirror 12 may also include a tilt mechanism so that the mirror 12 can be tilted to compensate for any optical path change of the tilted lens 3 tilted at any degree and in any direction. In this way, even large tilts of the lens 3, in any direction, for example, horizontal or vertical tilts, that would usually not reach the sensor 13 can be deflected to the sensor 13 via the tilt-adjustable mirror 12.

In FIGS. 3a and 3b a vertical tilting of the lens 3 is described. Furthermore, other tilting motions of the lens 3, for example, horizontal tilting motions are also possible. The vertical and horizontal tilting motions of the lens 3 are illustrated by the arrows (see FIG. 3a and FIG. 3b).

Mirror 12 may for example be a MEMS mirror that can be tilted, wherein the tilting can be done horizontally or vertically to compensate for any horizontal or vertical tilt of the lens 3. Other mirrors that can be tilted in any direction may also be possible. Alternatively, other types of motions of the mirror 12, for example, translation motions closer or further away to the lens 3 may be possible. Alternatively, mirror 12 may comprise multiple mirrors, for example, a mirror array. Thus, adding new optical paths combined with mirrors may allow for an adjustable angle for a camera FoV.

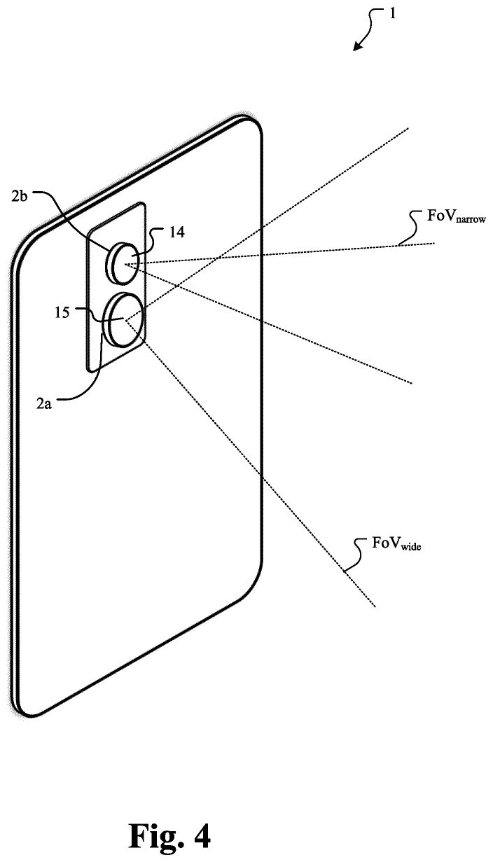

FIG. 4 schematically shows an embodiment of a mobile device with two camera modules including one wide angle lens. The mobile device 1 includes two camera modules 2a, 2b located on the rear side of the mobile device 1. A first camera module 2a comprises a wide-angle lens 15 and a second camera module 2b comprises a lens 14 with a longer focal length. Camera module 2a with the wide-angle lens 15 has a wider field-of-view FoV_{wide} than camera module 2b which has a narrow field-of-view FoV_{narrow}, as illustrated by the dashed lines in FIG. 4.

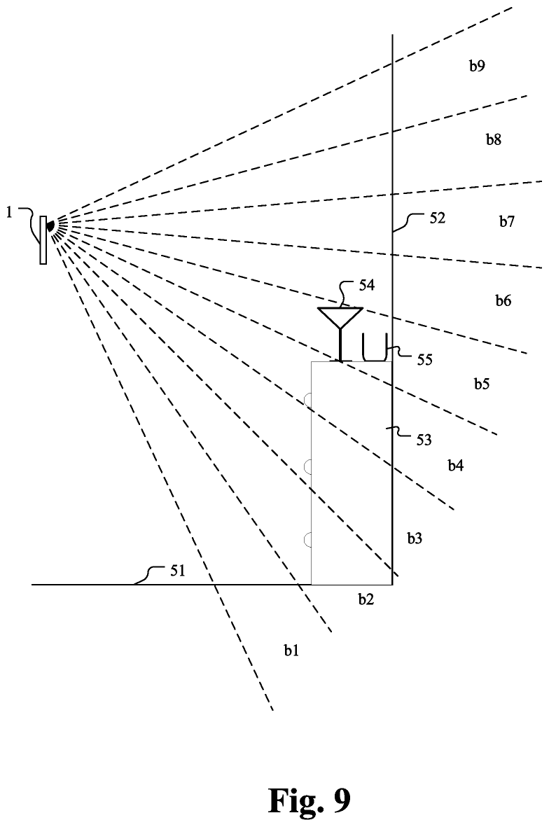

According to an embodiment, camera module 2b with the lens 14 with the narrower FoV includes a tilting mechanism such as described in FIGS. 2-3b above and camera module 2a with the wide-angle lens 15 may have a lower resolution than the camera module 2b. Camera module 2a with the wide-angle lens 15 may be used to scan the environment (possibly at a lower resolution) and may guide the tiltable camera module 2b with the lens 14 via a tilting mechanism to a region which is particularly suitable for purposes of tracking and visual positioning. That is, a region particularly suitable for purposes of tracking and visual positioning may originally not be within the FoV of camera module 2b. But as the camera module 2b includes a tilting mechanism, camera module 2b may be tilted in a way so that it points towards the region particularly suitable for purposes of tracking and visual positioning as identified based on the images provided by camera module 2a with wide-angle lens 2a. Camera module 2b may then image the region particularly suitable for purposes of tracking and visual positioning, and may provide, thanks to its longer focal length and potentially higher resolution, enhanced tracking and positioning for purposes of augmented reality (see FIGS. 9-11 and the corresponding description for more details).

According to yet alternative embodiments, the wide-angle lens 15 with the wider FoV_{wide} may be used for tracking and visual positioning for augmented reality purposes, while the lens 14 with the narrower FoV_{narrow} may be used to show a user the camera view on a display of the mobile device 1 for the purpose of AR applications. A virtual object may then be displayed to the user overlayed on the displayed view of camera module 2b with lens 14, whereas camera module 2a with wide-angle lens 15 is used to enhance tracking and positioning and thus the positioning of the virtual object on the display view.

Also, other configurations with multiple cameras at least one which may include a tilting mechanism as shown in FIGS. 2-3b are possible. Thus, a camera including a tilting mechanism, such as for example, a camera module 2b, may be tilted for correct VPS, while overlay is done on the view of another second camera FoV providing the actual view that a user is pointing the second camera towards. It should be noted that the second camera may be either a camera module 2b or a camera module 2a with a wide-angle lens 15. Alternatively, other configurations with multiple cameras at least one of which may be a camera with a wide-angle lens 15 are possible.

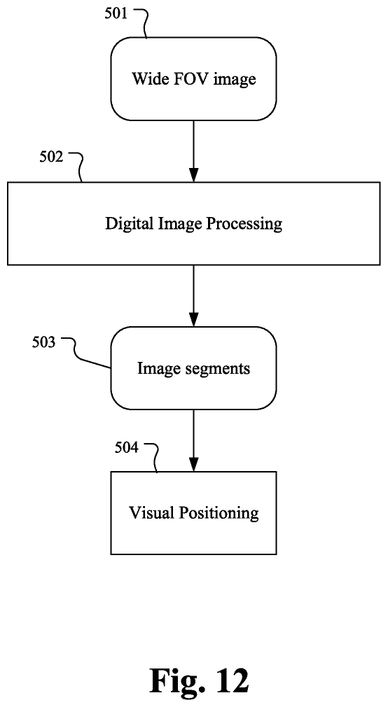

Thus, given that the mobile device 1 may have multiple camera modules 2a, 2b, the data from the wider angle-cameras, such as camera modules 2a, may be used to guide the adjustable-angle camera, such as camera module 2a. For example, if distinct objects are observed by a wide-angel camera, for example, camera module 2b, but details are not sufficient for precise VPS functionality, the VPS system may activate an implemented FoV adjustment for either using alternative optical paths, as for example described above in reference to FIGS. 3a and 3b, vary lens angles, as, for example, described above in reference to FIGS. 2, 3a and 3b, or correct using advanced methods, such as the image correction methods described below in reference to FIG. 12, for achieving the desired FoV to provide enough visual data to the VPS system for localization.

FIG. 5 schematically shows an example of a configuration of a visual positioning system with tilt adjustment procedure for a camera of a mobile device, the camera including a tilting mechanism. A scene (not shown) is captured by a camera 2. Camera 2 may provide e.g., an RGB/LAB/YUV image of the scene. Camera 2 includes a tilting mechanism such as described in FIGS. 2-3b. The image obtained from the camera 2 is forwarded to a 3D reconstruction 204.

3D reconstruction 204 creates and maintains a three-dimensional (3D) model of the imaged scene. In particular, 3D reconstruction 204 comprises a pose estimation 204-1 which receives the image data. The pose estimation 204-1 extracts sparse or dense visual features to perform visual odometry and thereby determines the position and orientation of the current camera pose. The pose estimation 204-1 further receives auxiliary input from auxiliary sensors 203, and a current 3D model from a 3D model reconstruction 204-2.

The auxiliary sensors 203 include a Time of Flight (ToF) camera 203-1 that provides measurements that are processed into point cloud information of the scene. Based on the image data, the auxiliary input including the ToF point cloud, and the current 3D model, the pose estimation 204-1 applies algorithms to the measurements to determine the pose of the camera (defined by e.g., position and orientation) in a global scene (“world”). Such algorithms may include for example the iterative closest point (ICP) method between point cloud information and the current 3D model, or for example a SLAM (Simultaneous localization and mapping) pipeline. Regarding the ToF point cloud data, knowing the camera pose, the pose estimation 204-1 “registers” the ToF point cloud to the global scene, thus producing a registered point cloud which represents the point cloud in the camera coordinate system as transformed into a global coordinate system (e.g., a “world” coordinate system) in which a model of the scene is defined.

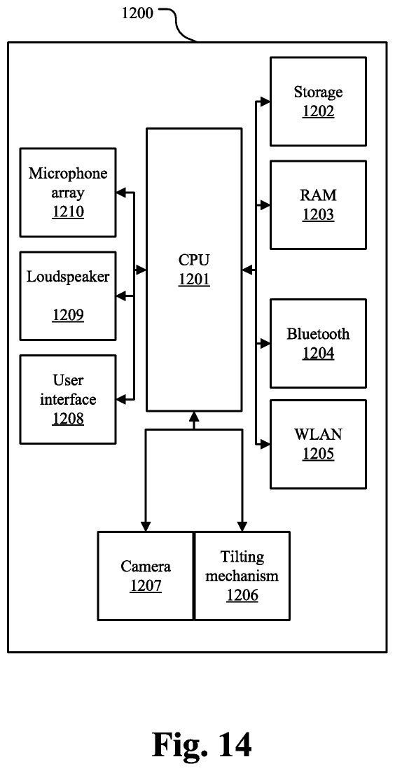

As described in more detail in FIGS. 1 to 3b above, the camera 2 (and also the auxiliary sensors 203) described in FIG. 5 above may for example be part of a mobile device (1 in FIGS. 1, 4). 3D reconstruction 204 may be implemented in one or more processors, e.g., processors such as the CPU 1201 of FIG. 14.

The image data obtained by the pose estimation 204-1 and the registered point cloud obtained by the pose estimation 204-1 is forwarded to a 3D model reconstruction 204-2. The 3D model reconstruction 204-2 updates a 3D model of the scene based on the image data obtained from the pose estimation 204-1 and based on auxiliary input obtained from the auxiliary sensors 203.

The auxiliary sensors 203 may further comprise an event-based camera 203-2 providing e.g., high frame rate cues for visual odometry from events. The auxiliary sensors 203 may further comprise an inertial measurement unit (IMU) 203-3 which provides e.g., acceleration and orientation information, that can be suitably integrated to provide pose estimates.

The auxiliary sensors 203 gather information about the scene in order to aid the 3D reconstruction 204 in producing and updating a 3D model of the scene.

According to an embodiment, 3D reconstruction 204 of FIG. 5 receives ToF point clouds and produces a 3D model of the scene 201 while simultaneously tracking the ToF camera's motion (i.e., the ToF camera's current pose). This problem is also known to the skilled person as “Simultaneous localization and mapping”. Several methods exist to solve this for example Extended Kalman Filter Based SLAM, Parallel Tracking and Mapping or the like. An overview of different SLAM methods is for example given in the paper C. Cadena et al., “Past, Present, and Future of Simultaneous Localization and Mapping: Towards the Robust-Perception Age,” IEEE Transactions on Robotics, vol. 32, no. 6, pp. 1309-1332, 2016. Still further, 3D reconstruction may for example be implemented according to the approach proposed by R. A. Newcombe et. al. in “KinectFusion: Real-time dense surface mapping and tracking”, 2011 10th IEEE International Symposium on Mixed and Augmented Reality, 2011, pp. 127-136 (also referred to below as “KinectFusion” approach). KinectFusion describes a technology in which a real-time stream of depth maps is received, and a real-time dense SLAM is performed, producing a consistent 3D scene model incrementally while simultaneously tracking the ToF camera's agile motion using all of the depth data in each frame.

Auxiliary sensor data (e.g., from the auxiliary sensors 203 of FIG. 2) may optionally be used at several stages to improve the 3D model reconstruction. The main use may be the providing of additional data streams that can be used to refine or optimize the quality of the pose estimation (204-1 in FIG. 1), by fusing diverse cues and complementary features in the sensor data. For example, the extraction of sparse features from RGB frames may be used to perform visual odometry by finding feature correspondences in consecutive frames. Therefore, sensor data may be used jointly to estimate a single pose in the pose estimation (for example an ICP method or a SLAM pipeline). The auxiliary sensor unit and the ToF system may operate in sensor fusion camera kits for a specified target use-case.

It should be noted that auxiliary sensors 203 such as ToF camera 203-1, inertial measurement unit 203-2 and event-based camera 203-3 described in FIG. 5 are optional. For example, 3D reconstruction 204 does not necessarily require data from a ToF camera 203-1 in order to perform pose estimation 204-1 and 3D model reconstructions 204-2. According to some embodiments, pose estimation 204-1 and 3D model reconstructions 204-2 is based only on image data from camera 2, e.g. using SLAM technology. Still further, it should be noted that pose estimation 204-1 does not necessarily need information from camera 2 or an auxiliary ToF camera 203-1. It might determine the position and orientation of the mobile device from data received from a GPS sensor and inertial measurement unit 203-2 alone.

The updated 3D model of the scene may be stored in a 3D model memory (not shown, for example the storage 1202 of FIG. 14).

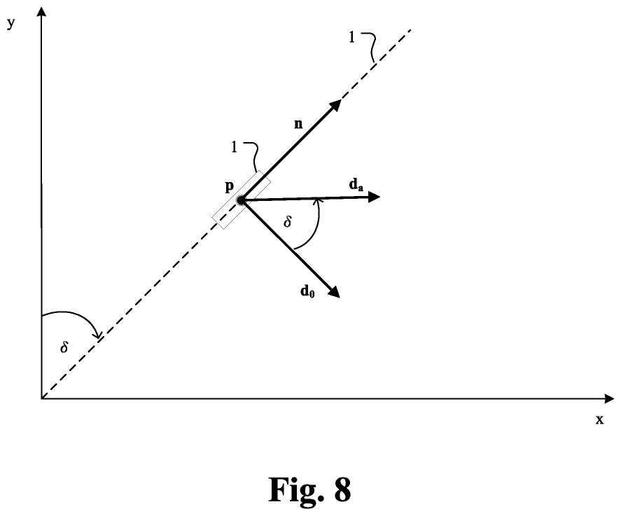

The updated 3D model of the scene is provided to the tilt adjustment 205. The tilt adjustment 205 determines based on the camera pose determined by pose estimation 204-1 (see e.g. FIG. 8 and corresponding description) and/or based on the 3D model of the scene (see e.g. FIGS. 9-11 and corresponding description) an adjusted camera tilt which realizes a new camera pose within the scene.

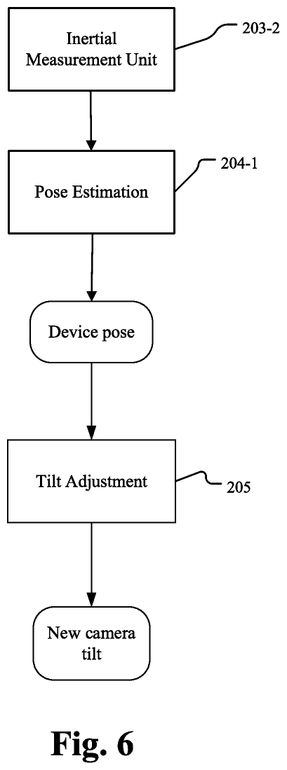

FIG. 6 schematically shows an example of a configuration of a tilt adjustment procedure for a camera for adjusting the field of view (FoV) of the camera to enhance tracking and visual positioning, the tilt adjustment being based on information from an inertial measurement unit. An inertial measurement unit 203-2 sends information regarding acceleration and orientation of a mobile device (1, see FIGS. 1, 2, 4) to a pose estimation 204-1. The pose estimation 204-1 applies algorithms to the acceleration and orientation information to determine the pose of the device (defined by e.g., position and orientation) in a global scene (“world”). The device pose information obtained by the pose estimation 204-1 is forwarded to a tilt adjustment 205. The tilt adjustment 205 determines based on the device pose a new camera tilt that the tilt mechanism should implement to achieve a predetermined camera angle within a global scene (“world”). The details on which camera tilt the tilt mechanism should implement are explained with regard to FIGS. 7 to 9.

The pose estimation 204-1 and the tilt adjustment 205 may be implemented in one or more processors, e.g., processors such as the CPU 1201 of FIG. 14.

In the embodiment of FIG. 6, the tilt adjustment 205 is performed based on a device pose obtained from an inertial measurement unit 203-2. It should be noted that, in alternative embodiments, the tilt adjustment 205 may also be based on a device pose that is obtained from additional information, such as image data from a camera (2 in FIG. 5), a ToF camera (203-1 in FIG. 5), or other auxiliary sensors such as described in FIG. 5 above.

FIG. 7 schematically shows a user holding a mobile device including a camera in different device tilt positions and how a tilting mechanism included in the camera for adjusting the field of view (FoV) of the camera to enhance tracking and visual positioning may compensate for a device tilt. The user 50 is holding a mobile device 1 while walking. The user 50 watches the display of the device which displays information from an augmented reality application. For example, the display may show the user 50 the view of the rear-facing camera (not shown, see 2, FIGS. 1, 2, 4) overlayed by virtual objects. For the purpose of showing the user 50 an augmented reality, tracking and visual positioning of a visual positioning system (VPS) is implemented.

FIG. 7a shows the user 50 comfortably holding the mobile device 1. The rear-facing camera's FoV is directed slightly towards the floor 51 as the mobile device 1 including the camera is aimed downwards in the direction of the floor 51. However, floor 51 towards which the camera is directed does not provide enough structural information for tracking and/or localization purposes. Thus, the rear-facing camera might not be able to provide reliable data for the visual positioning system, as the image data of the floor captured by the camera may not be sufficient for visual positioning. For example, if a mobile phone is held in normal use, it may typically be tilted down at around 45° angle. That is when, as mentioned above, mostly the floor may be visible to the rear-facing camera, which as explained may not be useful for VPS.

Alternatively, similar issues may arise for other wearable devices which might contain a camera for AR, MR or XR applications: for example, smart glasses, head-mounted displays (HMDs), earphones or other types of smart wearable devices, or the like. It should be noted that the user 50 in the example of FIG. 7a may want to see the area in front of him/her, for example the floor, possibly overlaid with augmented navigation signs, but the viewed scenery may not have sufficient and distinct details, which are needed for VPS. Such details are typically at the horizon level, such as façades of surrounding buildings, trees, street signs, etc. Thus, the mobile device, for example, smartphone, may be tilted at about 0° as indicated in FIG. 7b for better VPS.

Alternatively, there may be use-cases, where no live AR view is needed for the user 50. E.g., when using an AR navigation app, the user may walk for some extended period of time and may only check the AR navigation at some crossroad sections. In that case, the pointed camera angle will coincide with the VPS tracking angle (around the horizon).

FIG. 7b shows the user 50 holding the mobile device 1 upright. In this position the camera's FoV is aimed at the horizon. Typically, at horizon level the most objects of a scene are located, which allows for more reliable visual data for VPS than visual data from a camera whose FOV is aimed upwards, above the horizon, or downward, below the horizon. However, for the user 50 it is an obtrusive and uncomfortable way to hold the mobile device 1. It is more comfortable to hold the device as shown in FIG. 7a tilted downwards towards the floor.

FIG. 7c shows the user 50 holding the mobile device 1 comfortably tilted towards the floor in the way of FIG. 7a. The camera of FIG. 7c includes and implements a tilting mechanism (see FIGS. 2-3b) for making the field of view (FoV) of the camera independent of the device tilt. Therefore, the FoV of the camera is adjusted from the FoV_{non-tilted} to the FoV_{tilted} via the tilting mechanism of the camera. The FoV_{tilted} covers the horizon which is a more convenient FoV for visual positioning as the horizon includes the most objects which produces the best image data for visual positioning. The FoV_{tilted} covers the same FoV as the FoV of the camera of FIG. 7b, but without the mobile device 1 needing to be tilted in an inconvenient upright way for the user 50. In other words, the user 50 is holding the mobile device comfortably, but the movable FoV-system adjusts to provide the front-facing FoV for precise VPS.

Hence, a mechanism in a visual capturing system, for example, a portable or wearable device, may be used to allow the change of angle for the FoV to effectively become independent of a device tilt for regular use cases. The angle for the camera FoV may be adjusted in several ways, such as for example described in reference to FIGS. 2 to 4. This way, even if the device is not pointed towards the objects allowing for reliable and precise use of VPS, the camera may adjust accordingly to enable precise tracking and matching to ground-truth maps. For that purpose, AR navigation applications may be used, for example Google Maps AR, or the AR engine of Niantic Lightship that may be used for gaming or the like, or similar services. The details on how the camera may be tilted according to the example shown in FIG. 7c are shown in FIG. 8.

FIG. 8 schematically shows a configuration of a tilted mobile device with a camera including a tilting mechanism for adjusting the field of view (FoV) of the camera to enhance tracking and visual positioning. For simplification, FIG. 8 shows a 2D view of the configuration. A world coordinate system with axis x representing a horizontal direction in the world and an axis y representing a vertical direction in the world is illustrated. The mobile device 1 is positioned at position p within the world coordinate system. The mobile device 1 is tilted at an angle δ towards the horizontal direction x. Vector n illustrates the tilt direction of the mobile device 1 within the world coordinate system which reflects the tilted mobile device 1 of FIG. 7c. A camera (not shown, see 2 of FIGS. 1, 2, 4) included in mobile device 1 is positioned at position p. An original direction in which the camera is aimed is the direction d₀. This original direction d₀ represents the standard orientation of the camera which is normal to the surface of the mobile device. That is, in the original orientation, the direction d₀ is at 90° degrees with respect to tilt direction n of mobile device 1. Tilt adjustment (205 in FIG. 5 or 6) tilts the camera upwards at the angle δ, in order to aim the camera in the adjusted direction dₐ which is congruent with the horizontal direction x of the world coordinate system. By tilting the camera by the angle δ the device tilt is compensated by the tilt of the camera, so that the camera is aimed at the horizon in the horizontal direction x, as it is described with regard to FIG. 7c above.

The tile angle δ of the mobile device in the word coordinate system may for example be obtained from a pose estimation (204-1 in FIGS. 5 and 6) based on information from an inertial measurement unit (203-2 in FIG. 5 or 6) and/or from information obtained from a camera (2 in FIG. 5) or auxiliary sensors (203 in FIG. 5), such as described with regard to FIGS. 5 and 6 above.

FIG. 9 schematically shows a configuration of a visual guidance of a camera of a mobile device including a tilting mechanism. A camera (not shown, see 2, FIGS. 1, 2, 4) of a mobile device 1 including a tilting mechanism is positioned in a room. The room is illustrated in a side-view. The room includes various objects 51, 52, 53, 54, 55, such as a floor 51, a wall 52, a chest of drawers 54 standing on floor 51 and in front of wall 52, and a glass 55 and a cup 54 positioned on top of the chest of drawers 53. The possible tilting angles of the camera (the tilting space) is divided into angular sectors b1 to b9 as illustrated by the dashed lines. The camera of mobile device 1 is tilt-adjustable so that it can be directed into any one of the angular sectors b1 to b9. In particular, the tilt adjustment of mobile device 1 is configured to direct the camera into a direction which covers a region of the room which is most suitable for the purpose of tracking and visual positioning (VPS). The angular sector b1 includes floor 51 only. That is, the structural information available in sector b1 for the purpose of localization and tracking is minimal. The angular sectors b2, b3 and b4 include part of the chest of drawers. That is, there is some structural information available in sector b2, b3 and b4 for the purpose of localization and tracking. The angular sector b5 includes objects, namely part of the chest of drawers 53 as well as the objects positioned on top of the chest of drawers 53, such as glass 55 and cup 54. That is, the structural information available in sector b5 for the purpose of localization and tracking is maximal. The angular sectors b6, b7, b8 and b9 include only wall 52. That is, like in the case of sector b1 containing only floor 51, the structural information available in sectors b6, b7, b8 and b9 for the purpose of localization and tracking is again minimal.

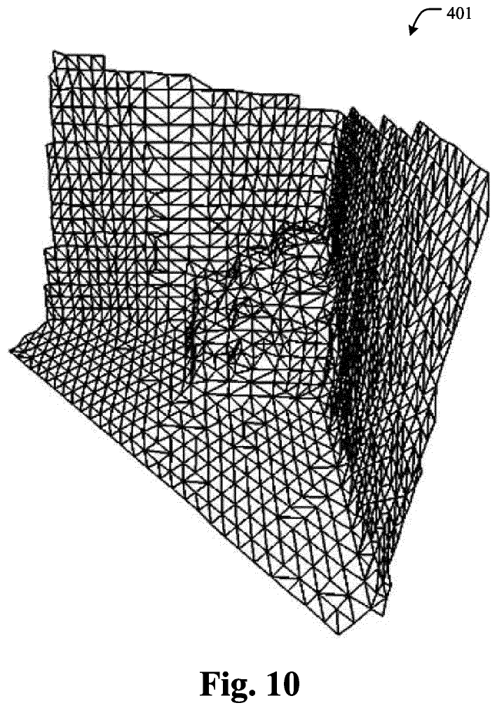

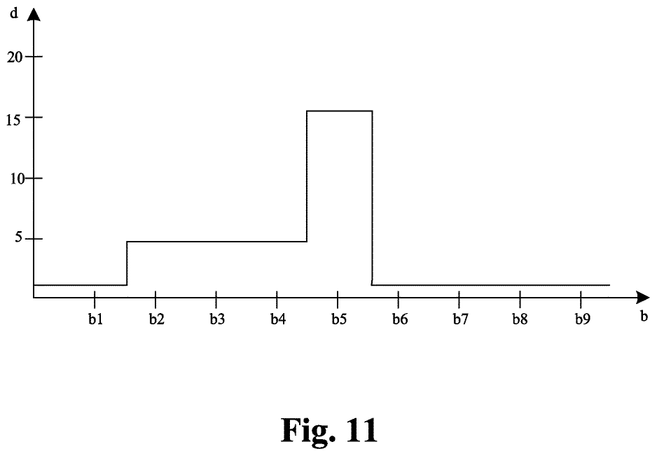

A tracking and visual positioning system (VPS) for virtual reality or augmented reality depends on reliable visual data, which may be more likely to be generated by a camera aimed at a location including a high number of objects, respectively structure. As illustrated in FIG. 7c this may often be the horizon. However, in FIG. 9, the angular sector b7 covers the horizon and merely includes the wall, which may not be sufficient for VPS. By contrast, the angular sector b5 includes more objects. Thus, the ideal FoV of the camera for VPS covers the angular sector b5. Accordingly, the number of surface elements of the 3D mesh is highest at angular sector b5. The tilt adjustment will use the information that the angular sector b5 includes the highest number of surface elements to trigger the tilt mechanism of the camera in a way that the camera is tilted according to the angular section b5. In other words, the FoV of the camera is adjusted to cover the angular sector b5 for VPS. Further details regarding the guidance of the camera's tilting mechanism according to the 3D mesh model generated within the angular sectors are explained in regard to FIGS. 10 and 11.

As described above, the tilt adjustment of the camera is implemented by taking into consideration the available structural information in the angular sectors. For that purpose, according to an embodiment, a 3D polygon mesh model (as obtained e.g., from 3D model reconstruction 204-2 in FIG. 5) comprising surface elements, e.g., polygons of the objects 51 to 55 located within the angular sectors b1 to b9 may be used. The number of surface elements of the mesh within an angular sector b1 to b9 corresponds to the density of structure within the sector. Therefore, according to the number of surface elements of the mesh included in each angular sector b1 to b9 the density of structure in a sector may be calculated. In consequence, a high number of surface elements may correspond to a higher amount of structure.

Alternatively, visual guidance may be implemented based on the texture of objects. Thus, the camera may be guided towards textured objects, rather than towards plain surfaces, such as a floor for example, which are, as mentioned above, typically difficult to use for localization and/or tracking.

FIG. 10 shows an example of a 3D model of a detail of a scene as produced by 3D reconstruction such as described in FIG. 5 and as used for tilt adjustment as described in FIG. 9.

The 3D model is implemented as a triangle mesh grid 401. This triangle mesh may be a local or global three-dimensional triangle mesh. In alternative embodiments a 3D model may also be described by a local or global voxel representation of a point cloud (uniform or octree); a local or global occupancy grid; a mathematical description of the scene in terms of planes, statistical distributions (e.g., Gaussian mixture models), or similar attributes extracted from the measured point cloud.

In another embodiment a model may be characterized as a mathematical object that fulfills one or more of the following aspects: it is projectable to any arbitrary view, it can be queried for nearest neighbors (closest model points) with respect to any input 3D point, it computes distances with respect to any 3D point cloud, it estimates normals and/or it can be resampled at arbitrary 3D coordinates.

The model may for example be implemented as a triangle mesh grid (e.g., a local or global three-dimensional triangle mesh), a local or global voxel representation of a point cloud (uniform or octree), a local or global occupancy grid, a mathematical description of the scene in terms of planes, statistical distributions (e.g., Gaussian mixture models), or similar attributes extracted from the measured point cloud. The model is typically constructed progressively by fusing measurements from available data sources, e.g., including but not limited to depth information, color information, inertial measurement unit information, event-based camera information.

When using the density of structure for guiding a camera to optimize localization and tracking, the tilt adjustment may be based on the angular density of surface elements and/or on the angular density of voxels described by the 3D model.

Classification techniques are known to the skilled person which may structure a detected scene into different objects, e.g., floor, furniture, walls, etc. These classification techniques can be for example pattern matching and might be based on manual feature extraction such as a histogram of oriented gradients. Further techniques can use convolutional neural networks, deep learning in general or a “You Only Look Once” classifier.

Object classification may also be utilized to identify which objects are movable, and which are static in the environment, thus further improving the VPS and/or SLAM system (see also explanation on 3D model reconstruction and SLAM above with reference to FIG. 5, FIG. 10).

FIG. 11 shows a graph of surface element density according to angular sectors. The b axis of the graph reflects the angular sectors b1 to b9 as illustrated and described in regard to FIG. 9. The d axis of the graph shows the number of surface elements of a 3D mesh model produced based on image data from a camera imaging within the angular sectors. The angular sector b1 contains few, below 5, surface elements, which reflects that the angular sector b1 as illustrated by FIG. 9 only includes the floor. The angular sectors b2 to b4 contain 5 surface elements, which also reflects a small number of objects located within the angular sectors b2 to b4. The angular sector b5 contains over 15 surface elements, which is the highest number of surface elements within the angular sectors b1 to b9, and reflects that within the visual scene as illustrated by FIG. 9, the angular sector b5 below the horizon (angular sector b7) contains the most objects. By contrast the angular sectors b6 to b9 only contain below 5 angular sectors, which reflects that within the angular sectors b6 and b7 only the wall is located, but no other objects that may be used for VPS are located. As described in regard to FIG. 9, the tilt adjustment of FIGS. 5 and 6 will induce the tilting mechanism of the camera (not shown, see 2, FIGS. 1, 2, 4) to adjust the camera FoV in the direction of the section b5, as this is the direction which will produce the best image data for VPS.

FIG. 12 shows a block diagram depicting an embodiment of a visual positioning process using image data of a wide-angle camera. A wide FoV image 501 is provided from a wide-angle camera (see 2a in FIG. 4) to a digital image processing 502. The digital image processing 502 may for example use the image information of the wide FoV image 501 to correct the image and segment the image into image segments 503. The image segments 503 may be used to enhance localization and tracking for a precise overlay of AR/VR information. Known classification techniques, as described above, may be utilized to determine the image segments 503 by segmenting a detected scene based on different objects, e.g., floor, furniture, walls, etc. The image segments 503 may then be matched to a pre-determined map or a map, such as a 3D model of the scene, that is created and updated based on the image segments 503 (see explanation on 3D model reconstruction and SLAM above with reference to FIG. 5, FIG. 10). Usual wide FoV images 501 without image correction contain imprecise or distorted edge information, which cannot be used for VPS. For example, by correcting the image edges of the wide FoV image and generate segmented FoV images containing the corrected edge information, the image data of the wide angle camera can be used for VPS. Although, a user may not be presented with the edge information of the wide FoV image on a display, VPS may use the segmented FoV image in the background to provide sophisticated augmented reality to the user.

Still further, according to an alternative embodiment, the information available in the outer regions of a wide-angle camera image may be used to guide a tiltable camera into a direction which provides good information for the purposes of localization and mapping.

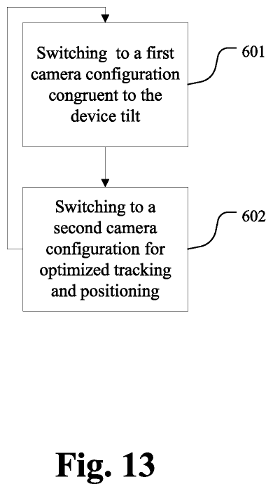

FIG. 13 shows a block diagram depicting the switching of the field of view of a camera between a field of view congruent to the device tilt and an adjusted field of view for enhanced tracking and visual positioning. The camera (see 2 of FIGS. 1, 2, 4) switches between a first camera configuration 601, wherein the camera is angled congruent to the device tilt of a mobile device (1 of FIG. 1), and a second camera configuration 602, wherein the camera is angled in a direction optimized for tracking and visual positioning. Thus, in 601 the camera is switched to a FoV congruent to the device tilt angle. Whereas in 602 the FoV of the camera is optimized for tracking and visual positioning.

The camera adjustment may happen fast enough to seamlessly switch from the angle of the device, for example a 45° angle, to the optimum VPS angle, for example, a 0° tilt, which may indicate the horizon. That way, the user of the mobile device (1 of FIG. 1) may be able to see overlayed augmented reality features, possibly on a display of the mobile device or the like, wherein the camera view of the first configuration is seen overlayed by augmented reality features, while at almost the same time, tracking may be happening with camera input at the extended angle, which is the angle of the camera in the second camera configuration, for example when the camera is facing the horizon.

Alternatively, in another embodiment, one tilted camera may be tilted for correct VPS, while overlay is done on the view of another camera FoV providing the actual view that the user is pointing the camera towards, as is for example described above with reference to FIG. 4.

Alternatively, fast switching between rear- and front-facing cameras may also be deployed to find an optimized or ideal VPS tracking space.

FIG. 14 shows a block diagram depicting an embodiment of an electronic device, e.g., a mobile device such as a smartphone or the like, that can implement the process of tilt adjustment for a camera including a tilting mechanism for adjusting the field of view (FoV) of the camera to enhance tracking and visual positioning. The electronic device 1200 comprises a CPU 1201 as processor. The electronic device 1200 further comprises a microphone array 1210, a loudspeaker array 1209, a camera 1207, and a tilt adjustment mechanism 1206 that are connected to the processor 1201. The processor 1201 may for example implement an AR application, a 3D reconstruction (204 in FIG. 5), a pose estimation (204-1 in FIG. 5), a 3D model reconstruction (204-2 in FIG. 5), a tilt adjustment (205 in FIG. 5) that realize the processes described with regard to FIGS. 5 and 6 in more detail. Loudspeaker 1209 may be headphones, e.g., on-ear, in-ear, over-ear, wireless headphones and the like, or may consist of one or more loudspeakers that are distributed over a predefined space and is configured to render any kind of audio, such as 3D audio. The microphone 1210 may be configured to receive any kind of audio signal.

The electronic device 1200 further comprises a user interface 1208 that is connected to the processor 1201. This user interface 1208 acts as a man-machine interface and enables a dialogue between a user and the electronic device. For example, a user may make configurations to the system using this user interface 1208. The electronic device 1200 further comprises a Bluetooth interface 1204, and a WLAN interface 1205. These units 1204, 1205 act as I/O interfaces for data communication with external devices. For example, additional loudspeakers, microphones, and cameras, e.g., the ToF camera 203-1 or the event-based camera of FIG. 5, with WLAN or Bluetooth connection may be coupled to the processor 1201 via these interfaces 1204 and 1205.

The electronic device 1200 further comprises a data storage 1202 and a data memory 1203 (here a RAM). The data memory 1203 is arranged to temporarily store or cache data or computer instructions for processing by the processor 1201. The data storage 1202 is arranged as a long-term storage, e.g., for image data or the updated 3D model as described in relation to FIG. 5 obtained from the CPU 1201 that implements the 3D reconstruction 204.

The connection between the CPU 1201 and the camera 1207 may include a camera serial interface (CSI). The CSI is an interface between a camera 1207 and a host processor 1201. Thus, control signals and data from the CPU 1201 to the camera 1207 as well as from the camera 1207 to the processor 1201 may be sent.

The connection between the CPU 1201 and the tilt mechanism 1207 included in the camera 1207 may include an interface through which control signals from the CPU 1201 may be sent to the tilt mechanism 1206. Thus, the control signals regarding tilt from the tilt adjustment 205 implemented by the CPU 1201 are sent via the interface to the tilt mechanism 1206.

It should be noted that the description above is only an example configuration. Alternative configurations may be implemented with additional or other sensors, storage devices, interfaces, or the like.

The electronic device 1200 may be a mobile device (see 1 of FIG. 1) or any other kind of portable or wearable device, for example, for augmented reality applications, such as, for example, smart glasses, head mounted displays (HMDs) earphones or other types of smart wearable devices, or the like.

The method as described herein is also implemented in some embodiments as a computer program causing a computer and/or a processor, such as processor 1201 discussed above, to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

A method for controlling an electronic device, such as mobile device 1 discussed above, is described in the following. The method can also be implemented as a computer program causing a computer and/or a processor, such as processor 1201 discussed above, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) An electronic device (1, 1200) comprising circuitry configured to adjust the field of view (FoV) of a camera (2, 2a, 2b) to enhance tracking and/or visual positioning.
(2) The electronic device (1, 1200) of (1), wherein the circuitry is configured to adjust the field of view (FoV) of a camera (2, 2a, 2b) in order to compensate for device tilt (d).
(3) The electronic device (1, 1200) of (1) or (2), wherein the circuitry is configured to adjust the direction (dₐ) of the field of view (FoV) of the camera (2, 2a, 2b) to enhance tracking and/or visual positioning.
(4) The electronic device (1, 1200) of any one of (1) to (3), wherein the circuitry is configured to adjust the field of view (FoV) of the camera (2, 2a, 2b) by directing the field of view (FoV) at a predefined region.
(5) The electronic device (1, 1200) of any one of (1) to (4), wherein the circuitry is configured to adjust the field of view (FoV) of the camera (2, 2a, 2b) by directing the field of view (FoV) at the horizon.
(6) The electronic device (1, 1200) of any one of (1) to (5), wherein the circuitry is configured to adjust the field of view (FoV) of the camera (2, 2a, 2b) by directing the field of view (FoV) of the camera (2, 2a, 2b) at a region which is particularly suitable for the purpose of localization and/or tracking.
(7) The electronic device (1, 1200) of any one of (1) to (6), wherein the circuitry is configured to adjust the field of view (FoV) of the camera (2, 2a, 2b) by directing the field of view (FoV) of the camera (2, 2a, 2b) at a region which is particularly suitable for the purpose of tracking and/or visual positioning.
(8) The electronic device (1, 1200) of any one of (1) to (7), wherein the circuitry is configured to adjust the field of view (FoV) of the camera (2, 2a, 2b) by guiding the field of view (FoV) of the camera based on information describing structural density of a region.
(9) The electronic device (1, 1200) of any one of (1) to (8), wherein the circuitry is configured to adjust the field of view (FoV) of the camera (2, 2a, 2b) by guiding the field of view (FoV) of the camera based on information describing visual objects (51, 52, 53, 54, 55) imaged by the camera (2, 2a, 2b) or the texture of visual objects (51, 52, 53, 54, 55) imaged by the camera.
(10) The electronic device (1, 1200) of any one of (1) to (9), wherein the circuitry is configured to guide the field of view (FoV) towards the most reliable objects (53; 54; 55) for localization and/or tracking.
(11) The electronic device (1, 1200) of any one of (1) to (10), wherein the circuitry is configured to guide the field of view (FoV) towards the most reliable objects (53; 54; 55) for tracking and/or visual positioning.
(12) The electronic device (1, 1200) of any one of (1) to (11), wherein the circuitry is configured to adjust the field of view (FoV) of the camera (2, 2a, 2b) by switching between a predefined angle of the smartphone (1) and a second angle which is optimized for localization and/or tracking.
(13) The electronic device (1, 1200) of any one of (1) to (12), wherein the circuitry is configured to adjust the field of view (FoV) of the camera (2, 2a, 2b) by switching between a predefined angle of the smartphone (1) and a second angle which is optimized for tracking and/or visual positioning.
(14) The electronic device (1, 1200) of any one of (1) to (13), wherein the circuitry is configured to adjust the field of view (FoV) of the camera (2, 2a, 2b) by tilting the camera (2, 2a, 2b).
(15) The electronic device (1, 1200) of any one of (1) to (14), the electronic device (1, 1200) providing a lens (3) configuration to allow for varying field of view (FoV).
(16) The electronic device (1, 1200) of any one of (1) to (15), comprising circuitry configured to provide new optical paths (r1, r2) by controlling tiltable mirrors (12) or switching mirrors (12).
(17) The electronic device (1, 1200) of any one of (1) to (16), wherein the circuitry is configured to obtain a tilt angle (d) based on information from a pose estimation (204-1).
(18) The electronic device (1, 1200) of any one of (1) to (17), wherein the pose estimation is based on at least one of information obtained by an inertial measurement unit (203-2), image data obtained from a camera (2, 2a, 2b), or data obtained from a depth camera (203-1).
(19) The electronic device (1, 1200) of any one of (1) to (18), wherein the circuitry is configured to obtain wide-angle image data from a wide-angle camera (2a), and adjust the field of view (FoV) of the camera (2, 2a, 2b) based on wide-angle image data.
(20) The electronic device (1, 1200) of (19), wherein the circuitry is configured to implement digital image processing (502) on the wide-angle image data.
(21) The electronic device (1, 1200) of any one of (1) to (20), wherein the circuitry is configured to segment the field of view (FoV) of a camera (2, 2a, 2b) and use the information for localization and/or tracking.
(22) The electronic device (1, 1200) of any one of (1) to (21), wherein the circuitry is configured to segment the field of view (FoV) of a camera (2, 2a, 2b) and use the information for tracking and/or visual positioning.
(23) The electronic device (1, 1200) of any one of (1) to (22), wherein the adjustment of the field of view (FoV) is based on a machine learning algorithm or conventional algorithm.
(24) The electronic device (1, 1200) of any one of (1) to (23), wherein the circuitry is configured to switch between rear- and front-facing cameras (2, 2a, 2b) to find an optimal VPS tracking space.
(25) A method comprising adjusting the field of view (FoV) of a camera (2, 2a, 2b) so that it is independent of the device tilt (d).
(26) A computer program comprising instructions which, when executed by a processor, performs the method of (25).
(27) A non-transitory computer-readable recording medium that stores therein a computer program product, which, when executed by a processor, causes the method according to (25) to be performed.

1. An electronic device comprising circuitry configured to adjust the field of view of a camera to enhance tracking and/or visual positioning.

2. The electronic device of claim 1, wherein the circuitry is configured to adjust the field of view of a camera in order to compensate for device tilt.

3. The electronic device of claim 1, wherein the circuitry is configured to adjust the direction of the field of view of the camera to enhance tracking and/or visual positioning.

4. The electronic device of claim 1, wherein the circuitry is configured to adjust the field of view of the camera by directing the field of view at a predefined region.

5. The electronic device of claim 1, wherein the circuitry is configured to adjust the field of view of the camera by directing the field of view at the horizon.

6. The electronic device of claim 1, wherein the circuitry is configured to adjust the field of view of the camera by directing the field of view of the camera at a region which is particularly suitable for the purpose of tracking and/or visual positioning.

7. The electronic device of claim 1, wherein the circuitry is configured to adjust the field of view of the camera by guiding the field of view of the camera based on information describing structural density of a region.

8. The electronic device of claim 1, wherein the circuitry is configured to adjust the field of view of the camera by guiding the field of view of the camera based on information describing visual objects imaged by the camera or the texture of visual objects imaged by the camera.

9. The electronic device of claim 8, wherein the circuitry is configured to guide the field of view towards the most reliable objects for tracking and/or visual positioning.

10. The electronic device of claim 8, wherein the circuitry is configured to adjust the field of view of the camera by switching between a predefined angle of the smartphone and a second angle which is optimized for tracking and/or visual positioning.

11. The electronic device of claim 1, wherein the circuitry is configured to adjust the field of view of the camera by tilting the camera.

12. The electronic device of claim 1, the electronic device providing a lens configuration to allow for varying field of view.

13. The electronic device of claim 1, comprising circuitry configured to provide new optical paths by controlling tiltable mirrors or switching mirrors.

14. The electronic device of claim 1, wherein the circuitry is configured to obtain a tilt angle based on information from a pose estimation.

15. The electronic device of claim 1, wherein the pose estimation is based on at least one of information obtained by an inertial measurement unit, image data obtained from a camera, or data obtained from a depth camera.

16. The electronic device of claim 1, wherein the circuitry is configured to obtain wide-angle image data from a wide-angle camera, and adjust the field of view of the camera based on wide-angle image data.

17. The electronic device of claim 16, wherein the circuitry is configured to implement digital image processing on the wide-angle image data.

18. The electronic device of claim 1, wherein the circuitry is configured to segment the field of view of a camera and use the information for tracking and/or visual positioning.

19.-20. (canceled)

21. A method comprising adjusting the field of view of a camera so that it is independent of the device tilt.

22. A computer program comprising instructions which, when executed by a processor, performs the method of claim 21.
